(19) United States
(12) Patent Application Publication
(10) Pub. No.: US 2010/0119115 A1
(43) Pub. Date: May 13, 2010

(54) IMAGING SYSTEM FOR IMAGING AN OBJECT IN AN EXAMINATION ZONE

(75) Inventor: Roland Proksa, Eindhoven (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/518,475

(22) PCT Filed: Dec. 10, 2007
(86) PCT No.: PCT/IB07/54980

§ 371 Date: Dec. 21, 2009

(30) Foreign Application Priority Data
Dec. 15, 2006 (EP) 06126199.6

(51) Int. Cl. G06K 9/00; G01N 23/04

(52) U.S. Cl. 382/106; 378/62

(57) ABSTRACT

The invention relates to an imaging system for imaging an object (14) in an examination zone (5). The imaging system comprises a radiation source emanating radiation for illuminating the examination zone (5), a detection unit for generating detection values depending on the radiation after having passed the examination zone (5) and a moving unit for moving the 5 radiation source and the examination zone relative to each other along a first trajectory (15) and along a second trajectory (16). The position of at least one of the first trajectory (15) and of the second trajectory (16) with respect to the object is determined by a determination unit. The imaging system further comprises a reconstruction unit for reconstructing an image of the object (14) from the detection values using the determined position of the at least one of 10 the first trajectory (15) and the second trajectory (16).

### FIELD OF THE INVENTION

The invention relates to an imaging system for imaging an object in an examination zone. The invention relates further to a corresponding imaging method and computer program for imaging an object in an examination zone, and a corresponding image generation device, image generation method and computer program for generating an image of an object in an examination zone.

### BACKGROUND OF THE INVENTION

The U.S. Pat. No. 5,706,325 discloses a computed tomography imaging system, which comprises an X-ray source emanating X-ray radiation for illuminating an examination zone, a detection unit for generating detection values depending on the radiation after having passed the examination zone, and a moving unit for moving the X-ray source and the examination zone relative to each other along a first trajectory being a circular trajectory and along a second trajectory being a linear trajectory. This computed tomography imaging system further comprises a reconstruction unit for reconstructing an image of the object from the generated detection values. The reconstructed images of the object comprise artifacts which are, for example, caused by movements of the object.

### SUMMARY OF THE INVENTION

It is therefore an object of the present invention to provide an imaging system for imaging an object, wherein the imaging system generates images having less artifacts, which are, for example, caused by movements of the object, i.e. images having an improved image quality.

It is a further object of the invention to provide a corresponding imaging method and computer program for imaging an object and to provide a corresponding image generation device, image generation method and computer program for generating an image of an object.

In a first aspect of the present invention an imaging system for imaging an object in an examination zone is provided, wherein the imaging system comprises:
a radiation source emanating radiation for illuminating the object,
a detection unit for generating detection values depending on the radiation after having passed the object,
a moving unit for moving the radiation source and the examination zone relative to each other along a first trajectory and along a second trajectory,
a determination unit for determining the position of at least one of the first and of the second trajectories with respect to the object,
a reconstruction unit for reconstructing an image of the object from the detection values using the determined position of the at least one of the first and second trajectories.

The invention is based on the idea that, if the position of at least one of the first and of the second trajectories is determined with respect to the object and if this determined position is used for the reconstruction of an image of the object, the reconstructed image is corrected for movements of the object and the examination zone relative to each other. A position of the object within and relative to the examination zone, while the radiation source and the examination zone move relative to each other along the first trajectory, which is different to a position of the object within and relative to the examination zone, while the radiation source and the examination zone move relative to each other along the second trajectory, is corrected in the reconstructed image, because the determined position of at least one of the first and of the second trajectories with respect to the object is used for reconstruction. This reduces the artifacts within the reconstructed image and improves, therefore, the image quality.

In a preferred embodiment the moving unit is adapted such that the first and the second trajectories intersect each other, wherein the detection unit is adapted for detecting first detection values, while the radiation source and the examination zone move relative to each other along the first trajectory, and for detecting second detection values, while the radiation source and the examination zone move relative to each other along the second trajectory, wherein the determination unit is further adapted for:
determining similar first and second detection values,
determining the position of the radiation source on the first trajectory, which belongs to the similar first detection values, and the position of the radiation source on the second trajectory, which belongs to the similar second detection values,
determining the position of the at least one of the first and of the second trajectories such that the determined positions of the radiation source on the first trajectory and on the second trajectory are identical.

Since the position of at least one of the first and of the second trajectories is determined by using similar first and second detection values, the determination of the position of at least one of the first and of the second trajectories with respect to the object can easily and reliably be performed with low computational costs.

Detection values which correspond to the same position of the radiation source on the first trajectory or on the second trajectory are preferentially referred to as a projection.

It is further preferred that the imaging system comprises a provision unit for providing initial positions of the first and of the second trajectories, wherein the determination unit is adapted such that the position of one of the first and second trajectories remains unchanged and that the position of the other of the first and second trajectories is determined such that the determined positions of the radiation source on the first trajectory and on the second trajectory are identical. Since initial positions of the first and of the second trajectories are already provided, since the position of one of the first and of the second trajectories remains unchanged and since only the position of the other of the first and the second trajectories has to be determined, the computational costs for determining the positions of the first and of the second trajectories is reduced.

In a preferred embodiment, the moving unit is adapted for moving the radiation source and the examination zone relative to each other along a first trajectory such that the first detection values form an incomplete data set, wherein the moving unit is further adapted for moving the radiation source and the examination zone relative to each other along a second trajectory such that the first detection values and the second detection values together form a complete data set. An incomplete data set does not allow reconstructing the object without artifacts. In contrast, a complete data set allows reconstructing an artifact free image. Thus, the adaptation of the moving unit such that the radiation source and the examination zone move relative to each other along the first and the second trajectories such that the first detection values and the second detection values together form a complete data set, further reduces artifacts within the reconstructed image.

It is further preferred that the first trajectory is an axial trajectory located in a plane perpendicular to an axial direction, wherein the second trajectory is extended in the axial direction, wherein the determination unit is adapted for determining the position of at least one of the first and of the second trajectory with respect to the object only in the axial direction. The axial trajectory is, for example, a circular trajectory, and the second trajectory, which is extended in the axial direction, is, for example, a linear trajectory parallel to the axial direction or a helical trajectory whose axis coincides with the axial direction. Since it is known that a movement of the object relative to the examination zone in the axial direction causes strong motion artifacts while a movement of the object relative to the examination zone perpendicular to the axial direction causes small motion artifacts, the determination of the position of at least one of the first and of the second trajectories with respect to the object only in the axial direction yields a reconstructed image, wherein the motion artifacts are substantially eliminated and wherein the computational costs for the determination of the position of at least one of the first and of the second trajectories with respect to the object are further reduced.

In a further aspect of the invention an image generation device for generating an image of an object in an examination zone is provided, the image generation device being provided with detection values generated by a detection unit depending on radiation after having passed the examination zone, the radiation being emanated by a radiation source for illuminating the examination zone, the radiation source and the examination zone being moved relative to each other along a first trajectory and along a second trajectory by a moving unit, the image generation device comprising:
a determination unit for determining the position of at least one of the first and of the second trajectories with respect to the object,
a reconstruction unit for reconstructing an image of the object from the detection values using the determined position of the at least one of the first and second trajectories.

In a further aspect of the invention an imaging method for imaging an object in an examination zone is provided, wherein the imaging method comprises following steps:
illuminating the examination zone by radiation of a radiation source,
generating detection values depending on the radiation after having passed the examination zone by a detection unit,
moving the radiation source and the examination zone relative to each other along a first trajectory and along a second trajectory by a moving unit,
determining the position of at least one of the first and of the second trajectories with respect to the object by a determination unit,
reconstructing an image of the object from the detection values using the determined position of the at least one of the first and second trajectories by a reconstruction unit.

In a further aspect of the invention an image generation method for generating an image of an object in an examination zone by an image generation device is provided, the image generation device being provided with detection values generated by a detection unit depending on radiation after having passed the examination zone, the radiation being emanated by a radiation source for illuminating the examination zone, the radiation source and the examination zone being moved relative to each other along a first trajectory and along a second trajectory by a moving unit, the image generation method comprising following steps:
determining the position of at least one of the first and of the second trajectories with respect to the object,
reconstructing an image of the object from the detection values using the determined position of the at least one of the first and second trajectories.

In a further aspect of the invention a computer program for imaging an object in an examination zone is provided, wherein the computer program comprises program code means for causing a computer to carry out the steps of the method as claimed in claim 7, when the computer program is run on a computer controlling an imaging system as defined in claim 1.

In a further aspect of the invention a computer program for generating an image of an object in an examination zone is provided, wherein the computer program comprises program code means for causing a computer to carry out the steps of the method as claimed in claim 8, when the computer program is run on a computer controlling an image generation device as defined in claim 6.

It shall be understood that the imaging system of claim 1, the image generation device of claim 6, the imaging method of claim 7, the image generation method of claim 8, the computer program of claim 9 and the computer program of claim 10 have similar and/or identical preferred embodiments as defined in the dependent claims.

It shall be understood that preferred embodiments of the invention can also be any combination of the dependent claims with the respective independent claims.

### BRIEF DESCRIPTION OF THE DRAWINGS

These and other aspects of the invention will be apparent from and elucidated with reference to the embodiments described hereinafter. In the following drawings

FIG. 1 shows schematically a representation of an imaging system for imaging an object in an examination zone in accordance with the invention,

FIG. 2 shows schematically a flowchart illustrating a method for imaging an object in an examination zone in accordance with the invention,

FIG. 3 shows schematically a representation of a first trajectory and a second trajectory, along which a radiation source of the imaging system and the examination zone move relative to each other,

FIG. 4 shows schematically a representation of the first directory and another second directory, along which the radiation source and the examination zone move relative to each other, and

FIG. 5 shows schematically a flowchart illustrating an image generation method for generating an image of an object in an examination zone in accordance with the invention.

### DETAILED DESCRIPTION OF EMBODIMENTS

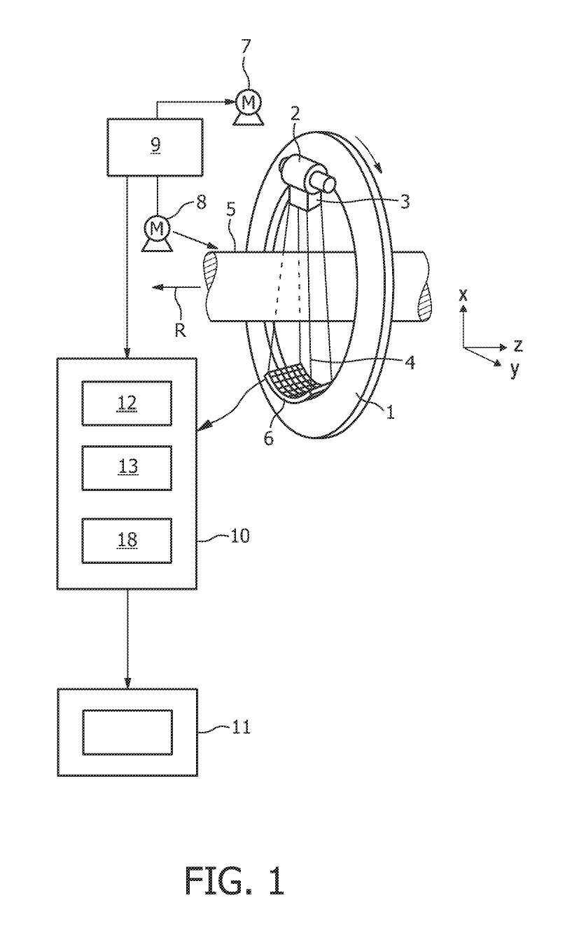

The imaging system for imaging an object in an examination zone shown in FIG. 1 is a computed tomography system. The computed tomography system includes a gantry 1 which is capable of rotating about an axis of rotation R which extends parallel to the z direction. A radiation source, which is in this embodiment an X-ray source 2, is mounted on the gantry 1. The X-ray source 2 is provided with a collimator device 3 which forms a conical radiation beam 4 from the radiation emitted by the X-ray source 2. In other embodiments the collimator 3 can be adapted for forming a radiation beam having another shape, for example, having a fan shape.

The radiation traverses an object (not shown), such as a patient or a technical object, in an examination zone 5. After having traversed the examination zone 5, the X-ray beam 4 is incident on a detection unit 6, in this embodiment a two-dimensional detector, which is mounted on the gantry 1. In other embodiments, the detection unit can also be a one-dimensional detector.

The gantry 1 is driven at a preferably constant, but adjustable angular speed by a motor 7. A further motor 8 is provided for displacing the examination zone 5, in which the object, for example, a patient, who is arranged on a patient table in the examination zone 5, is located, parallel to the direction of the axis of radiation R or the z axis. These motors 7, 8 and the gantry form a moving unit for moving the X-ray source 2 and the examination zone 5, relative to each other along a first trajectory and along a second trajectory. The motors 7, 8 are controlled by control unit 9 such that the radiation source 2 and the examination zone 5 move relative to each other along a first trajectory and along a second trajectory. The first trajectory is preferentially a circular trajectory, wherein the examination zone 5 is not moved and the X-ray source 2 is rotated. The second trajectory is preferentially a linear trajectory or a helical trajectory. For moving the X-ray source and the examination zone 5 relative to each other along a linear trajectory, which is preferentially arranged parallel to the axis of rotation R or the z axis, preferentially the X-ray source 2 is not rotated and the examination zone 5 is moved parallel to the axis of rotation R or the z axis. For moving the X-ray source 2 and the examination zone 5 relative to each other along a helical trajectory, preferentially the X-ray source 2 is rotated and the examination zone 5 is moved parallel to the axis of rotation R or the z axis.

The data acquired by the detection unit 6 are provided to an image generation device 10 for generating an image of an object. The generated image can finally be provided to a display unit 11 for displaying the generated image of the object.

The image generation device 10 for generating an image of an object comprises a determination unit 12 for determining the position of at least one of the first and of the second trajectories with respect to the object and a reconstruction unit 13 for reconstructing an image of the object from the detection values using the determined position of the at least one of the first and second trajectories. Also the image generation device 10 is preferentially controlled by the control unit 9.

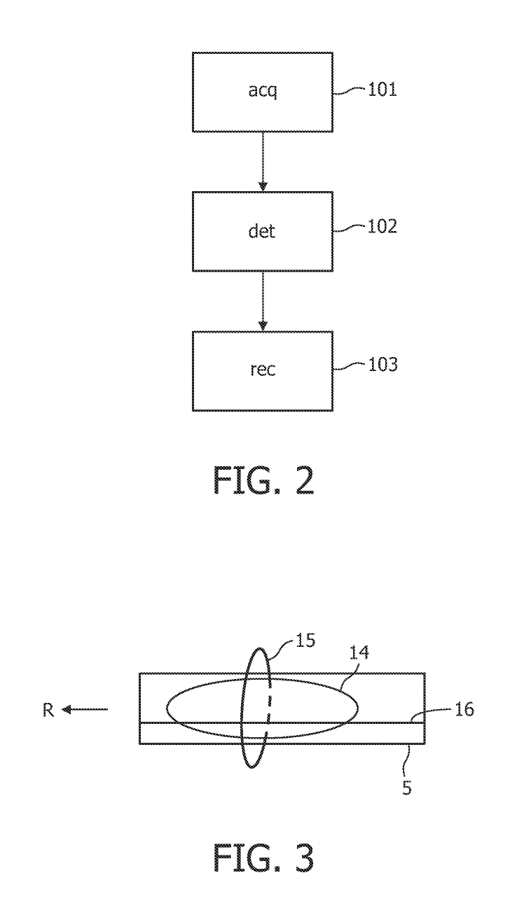

In the following an embodiment of an imaging method for imaging an object in an examination zone in accordance with the invention will be described in more detail with reference to the flowchart shown in FIG. 2.

In step 101 first detection values are acquired by the detection unit 6, while the X-ray source 2 and the examination zone 5 move relative to each other along the first trajectory, which is a circular trajectory in this embodiment, and second detection values are acquired by the detection unit 6, while the X-ray source 2 and the examination zone 5 move relative to each other along the second trajectory. The second trajectory is a linear trajectory arranged parallel to the z direction or the axis of rotation R. In other embodiments, for example, the second trajectory can also be a helical trajectory.

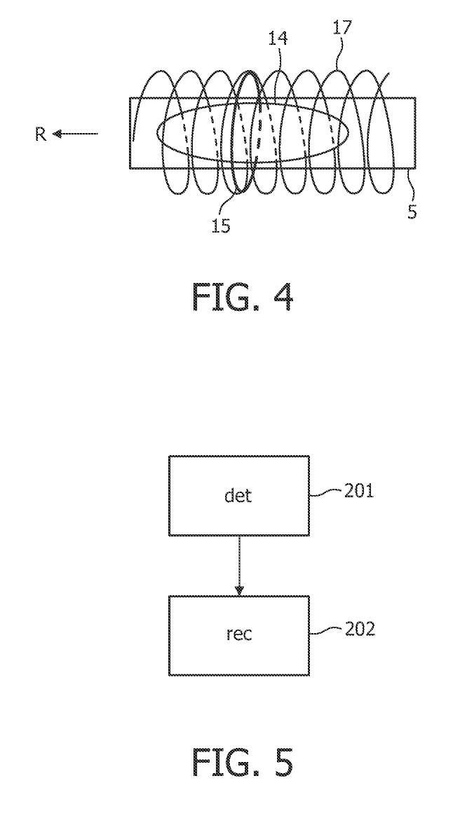

FIG. 3 shows schematically an object 14 in an examination zone 5, which is surrounded by a circular trajectory 15. FIG. 3 shows further schematically a second trajectory being a linear trajectory 16 arranged parallel to the axis of rotation R. FIG. 4 shows schematically the first trajectory 15 being also a circular trajectory surrounding the examination zone 5, and a second trajectory being a helical trajectory 17.

In step 102 the first and second detection values are transmitted to the determination unit 12 of the image generation device 10. The determination unit 12 determines the position of at least one of the first and of the second trajectories 15, 16 or 15, 17 with respect to the object 14. For determining the position of at least one of the first and of the second trajectories 15, 16 or 15, 17 with respect to the object 14 an intersection point of these two trajectories 15, 16 or 15, 17 with respect to the object 14 is determined. This intersection point is defined by a similarity of first and second detection values. This will be explained in more detail in the following.

First detection values, which correspond to the same position of the X-ray source 2 on the first trajectory, are referred to as first projection data. Second detection values, which correspond to the same position of the X-ray source 2 on the second trajectory, are referred to as second projection data. First projection data and second projection data are compared using a similarity measure. The similarity measure is, for example, the sum of the absolute differences, the sum of squared differences or a correlation. First projection data and second projection data are determined which comprise the largest similarity with respect to the used similarity measure. The position of the X-ray source 2 on the first trajectory 15, which corresponds to the determined most similar first projection data, and the position of the X-ray source 2 on the second trajectory 16 or 17, which corresponds to the most similar second projection data, define the intersection point between the first trajectory 15 and the second trajectory 16 or 17 with respect to the object.

Since the object 14 could have been moved with respect to the examination zone 5 between the acquisition of the first detection values and the acquisition of the second detection values, for example, because a patient on a patient table has moved relative to the patient table, the position of the X-ray source on the first trajectory 15, which corresponds to the most similar first projection data, and the position of the X-ray source 2 on the second trajectory 16 or 17, which corresponds to the most similar second projection data, do generally not coincide. In order to correct for this misalignment, which is caused by a movement of the object 14 relative to the examination zone 5, at least one of the first trajectory 15 and of the second trajectory 16 or 17 has to be moved such that the position of the X-ray source 2 on the first trajectory, which corresponds to the most similar first projection data, and the position of the X-ray source 2 on the second trajectory, which corresponds to the most similar second projection data, coincide.

Preferentially, the first trajectory 15 remains unchanged, and the second trajectory 16 or 17 is moved such that the above-mentioned coincidence of the positions of the X-ray source 2 on the first trajectory and on the second trajectory defining the intersection point is reached.

Preferentially, the position of at least one of the first and of the second trajectory with respect to the object is determined only in the axial direction. This means that at least one of the first trajectory 15 and of the second trajectory 16 or 17 is moved only in the axial direction, which is in this embodiment a direction parallel to the axis of rotation R, in order to reach the coincidence of the position of the X-ray source 2 on the first trajectory 15, which corresponds to the most similar first projection data, and the position of the X-ray source 2 on the second trajectory 16 or 17, which corresponds to the most similar second projection data.

The determination of the position of at least one of the first and of the second trajectory with respect to the object only in the axial direction does not mean that the intersection point of the first trajectory and the second trajectory cannot be moved in a direction, which is not the axial direction, caused by a movement of the object relative to the examination zone, but that the position of the intersection point in the axial direction is determined, wherein, for example, since the second trajectory can be a helical trajectory 17 and since the position of the intersection point has to be located on the second trajectory, the determined position of the intersection point can also be moved in a direction perpendicular to the axial direction with respect to an initial intersection point, wherein this movement is caused by a movement of the object relative to the examination zone in the axial direction.

The projection data of the circular first trajectory 15 can be parameterized by A(γ), wherein γ is gantry angle. Projection data from a linear second trajectory 16 can be parameterized by L(z), wherein z is the respective position along the axial direction and wherein the second projection data have been acquired while the X-ray source 2 was fixed at a gantry angle γ₀. In this case, preferentially the position z₀ along the axial direction is determined such that the second projection data L(z₀) are most similar to the first projection data A(γ₀). It is further preferred that the position of the first trajectory remains unchanged with respect to a provided initial first trajectory, and that the second trajectory 16 is moved such that at the position z₀ the first trajectory 15 and the second trajectory 16 coincide.

If the second trajectory is a helical trajectory 17, the second projection data can be parameterized by H(z), wherein the gantry angle at an axial position z is defined by δ(z). In this case, the intersection position is determined such that the second projection data H(z₀) are most similar to the first projection data A(δ(z₀)), i.e. the position z₀ along the axial direction is determined such that the projection data H(z₀) are most similar to the first projection data A(δ(z₀)). Also in this case, preferentially the position of the first trajectory remains unchanged, wherein the second trajectory is moved along the axial and/or angular direction such that a coincidence between the position of the X-ray source 2 on the first trajectory, which corresponds to the most similar first projection data, and the position of the X-ray source 2 on the second trajectory, which corresponds to the most similar second projection data, is reached.

Since the intersection point and the required correction and movement of at least one of the first and of the second trajectories is determined by comparing the first and second detection values, in particular by comparing the first projection data and the second projection data, the position of at least one of the first and of the second trajectories is determined with respect to the object.

The image generation device 10, and therefore the imaging system for imaging an object, can further comprise a provision unit 18 for providing initial positions of the first and of the second trajectories. This provision unit 18 is, for example, a receiver, which receives initial positions of the first and of the second trajectories from the control unit 9, or a memory unit, in which initial positions of the first and of the second trajectories are stored. The initial positions are preferentially the positions of the first and second trajectories with respect to the examination zone. If the object does not move relative to the examination zone during the acquisition of the first detection values and the second detection values, the determined intersection point between the first and the second trajectories generally coincides with the intersection point of the provided initial first and second trajectories, and a movement of at least one of the first and second trajectories for correcting a movement of the object relative to the examination zone is generally not required.

In step 103 an image of the object is reconstructed using the first and second detection values and the determined position of the at least one of the first and of the second trajectories. For example, a first image of the object is reconstructed using the first detection values and the determined position of the first trajectory and a second image is reconstructed using the second detection values and the determined second trajectory. The first image and the second image can be combined to a final image of the object.

The reconstruction of an object using first detection values and second detection values and known positions of first and second trajectories is known, for example, from “Cardiac Cone-beam CT Using a Circle and Line Acquisition and an Exact Reconstruction”, P. Koken, C. Bontus, Th. Köhler, M. Grass, IEEE Medical Imaging Conference, San Juan, Puerto Rico (2005), pp. 2355-2358, wherein the first trajectory is a circular trajectory and second trajectory is a linear trajectory. Furthermore, “Circular CT in Combination with a Helical Segment”, IEEE Medical Imaging Conference C. Bontus, P. Koken, Th. Köhler, San Diego, Calif. (2006) disclose a reconstruction technique for reconstructing an object, wherein the first trajectory is a circular trajectory and the second trajectory is a helical trajectory. These documents, in particular the reconstruction using as circular and a linear or helical trajectory, are herewith incorporated by reference.

The known reconstruction methods can be used for reconstructing an image of the object using the acquired first and second detection values and the determined positions of the first and second trajectories.

The circular trajectory 15 yields incomplete data only, i.e. the object 14 cannot be reconstructed without artifacts. The combination of this circular first trajectory 15 with the linear second trajectory 16 or the helical trajectory 17 yields a complete data set allowing reconstructing the complete object 14 without artifacts.

If the first and second detection values are already present, for example, because an acquisition of the first and second detection signals has already been performed, the image generation device 10 performs preferentially the steps illustrated in the flowchart shown in FIG. 5, in order to generate an image of the object from the already present first and second detection values. For this generation, in step 201, which corresponds to the above described step 102, the determination unit 12 of the image generation device 10 determines the position of at least one of the first and of the second trajectories with respect to the object. In step 202, the reconstruction unit 13 of the image generation device 10 reconstructs an image of the object from the first and second detection values using the determined position of the at least one of the first and second trajectories.

While the invention has been illustrated and described in detail in the drawings and foregoing description, such illustration and description are to be considered illustrative or exemplary and not restrictive. The invention is not limited to the disclosed embodiments.

A position of a trajectory can also include an orientation of the trajectory.

In a preferred embodiment, the position of both, the first trajectory and the second trajectory, is determined with respect to the object.

In the claims the word “comprising” does not exclude other elements or steps and the indefinite article “a” or “an” does not exclude a plurality. For example, the term “a first trajectory” does not exclude a plurality of first trajectories, and the term “a second trajectory” does not exclude a plurality of second trajectories. In the case of more than two trajectories, preferentially the determination unit determines for each trajectory most similar detection values and the positions of the trajectories are preferentially determined such that the positions of the radiation source on the respective trajectory, which correspond to the most similar detection values, coincide.

The object can be a whole object or a part of an object. For example, the object can be a technical object or a patient, or a part of the technical object or the patient, for example, a part of a human organ like a heart.

Although, in the above described embodiment, the correction of a movement of an object relative to an examination zone has been described, the invention is not limited to a movement of an object relative to the examination zone. For example, also the examination zone, i.e. the radiation unit and/or the detection unit and/or an arrangement for moving the examination zone linearly, like a patient table, can move relative to the object, and the invention can also correct this relative movement. The imaging system and image generation device in accordance with the invention are able to correct relative movements between the object and the examination zone, regardless of which of the object and the examination zone actually moves.

The mere fact that certain features are recited in mutually different dependent claims does not indicate that a combination of these features cannot be used to advantage.

A single unit may fulfill the functions of several items recited in the claims. For example, the determination unit and the reconstruction unit can be implemented as software fulfilling at least one of the above described functions or as dedicated hardware.

A computer program may be stored/distributed on a suitable medium such as an optical storage medium or a solid-state medium supplied together with or as part of other hardware, but may also be distributed in other forms, such as via the internet or other wired or wireless telecommunication systems.

Any reference signs in the claims should not be construed as limiting the scope of the invention.

1. An imaging system for imaging an object in an examination zone, wherein the imaging system comprises:
a radiation source emanating radiation for illuminating the examination zone,
a detection unit for generating detection values depending on the radiation after having passed the examination zone,
a moving unit for moving the radiation source and the examination zone relative to each other along a first trajectory and along a second trajectory,
a determination unit for determining the position of at least one of the first and of the second trajectories with respect to the object,
a reconstruction unit for reconstructing an image of the object from the detection values using the determined position of the at least one of the first and second trajectories.

2. The imaging system as claimed in claim 1,
wherein the moving unit is adapted such that the first and the second trajectories intersect each other,
wherein the detection unit is adapted for detecting first detection values, while the radiation source and the examination zone move relative to each other along the first trajectory, and for detecting second detection values, while the radiation source and the examination zone move relative to each other along the second trajectory,
wherein the determination unit is further adapted for:
determining similar first and second detection values,
determining the position of the radiation source on the first trajectory, which belongs to the similar first detection values, and the position of the radiation source on the second trajectory, which belongs to the similar second detection values,
determining the position of the at least one of the first and of the second trajectories such that the determined positions of the radiation source on the first trajectory and on the second trajectory are identical.

3. The imaging system as claimed in claim 2, wherein the imaging system comprises a provision unit for providing initial positions of the first and of the second trajectories, wherein the determination unit is adapted such that the position of one of the first and second trajectories remains unchanged and that the position of the other of the first and second trajectories is determined such that the determined positions of the radiation source on the first trajectory and on the second trajectory are identical.

4. The imaging system as claimed in claim 1, wherein the moving unit is adapted for moving the radiation source and the examination zone relative to each other along a first trajectory such that the first detection values form an incomplete data set and wherein the moving unit is further adapted for moving the radiation source and the examination zone relative to each other along a second trajectory such that the first detection values and the second detection values together form a complete data set.

5. The imaging system as claimed in claim 4, wherein the first trajectory is an axial trajectory located in a plane perpendicular to an axial direction, wherein the second trajectory is extended in the axial direction, wherein the determination unit is adapted for determining the position of at least one of the first and of the second trajectories with respect to the object only in the axial direction.

6. An image generation device for generating an image of an object in an examination zone, the image generation device being provided with detection values generated by a detection unit depending on radiation after having passed the examination zone, the radiation being emanated by a radiation source for illuminating the examination zone, the radiation source and the examination zone being moved relative to each other along a first trajectory and along a second trajectory by a moving unit, the image generation device comprising:
a determination unit for determining the position of at least one of the first and of the second trajectories with respect to the object,
a reconstruction unit for reconstructing an image of the object from the detection values using the determined position of the at least one of the first and second trajectories.

7. An imaging method for imaging an object in an examination zone, wherein the imaging method comprises following steps:
illuminating the examination zone by radiation of a radiation source,
generating detection values depending on the radiation after having passed the examination zone by a detection unit,
moving the radiation source and the examination zone relative to each other along a first trajectory and along a second trajectory by a moving unit,
determining the position of at least one of the first and of the second trajectories with respect to the object by a determination unit,
reconstructing an image of the object from the detection values using the determined position of the at least one of the first and second trajectories by a reconstruction unit.

8. An image generation method for generating an image of an object in an examination zone by an image generation device, the image generation device being provided with detection values generated by a detection unit depending on radiation after having passed the examination zone, the radiation being emanated by a radiation source for illuminating the examination zone, the radiation source and the examination zone being moved relative to each other along a first trajectory and along a second trajectory by a moving unit, the image generation method comprising following steps:
determining the position of at least one of the first and of the second trajectories with respect to the object,
reconstructing an image of the object from the detection values using the determined position of the at least one of the first and second trajectories.

9. Computer program for imaging an object in an examination zone, comprising program code means for causing a computer to carry out the steps of the method as claimed in claim 7.

10. Computer program for generating an image of an object in an examination zone, comprising program code means for causing a computer to carry out the steps of the method as claimed in claim 8.
